(19) United States
(12) Patent Application Publication
(10) Pub. No.: US 2014/0294016 A1
(43) Pub. Date: Oct. 2, 2014

(54) NETWORK COMMUNICATION APPARATUS AND FACSIMILE APPARATUS

(71) Applicant: KYOCERA Document Solutions Inc., Osaka (JP)

(72) Inventor: Kazunori Goto, Osaka (JP)

(73) Assignee: KYOCERA Document Solutions Inc., Osaka (JP)

(21) Appl. No.: 14/223,261

(22) Filed: Mar. 24, 2014

(30) Foreign Application Priority Data
Mar. 26, 2013 (JP) 2013-064739

(51) Int. Cl. H04L 29/06

(52) U.S. Cl. CPC H04L 65/604; H04L 65/1059
USPC 370/465

(57) ABSTRACT

A network communication apparatus receives packet data transmitted over an IP network in accordance with a transmission control scheme based on UDP. The network communication apparatus includes a last control signal determination portion, and a processing object exclusion portion. The last control signal determination portion determines whether a last control signal which is to be received in a last step in a continuous reception procedure of continuously receiving a plurality of the packet data, is included in one or a plurality of redundant packets added to the packet data received in the continuous reception procedure. The processing object exclusion portion, when the last control signal determination portion determines that the last control signal is included in the redundant packet, excludes the last control signal from processing objects to be processed in the network communication apparatus.

### INCORPORATION BY REFERENCE

This application is based upon and claims the benefit of priority from the corresponding Japanese Patent Application No. 2013-064739 filed on Mar. 26, 2013, the entire contents of which are incorporated herein by reference.

### BACKGROUND

The present disclosure relates to a network communication apparatus that receives packet data transmitted over IP network in accordance with a transmission control scheme based on User Datagram Protocol (UDP), and a facsimile apparatus including the network communication apparatus.

As international standards of data transmission procedures (data transmission protocols) by facsimile apparatuses, T series recommendations (T.30, T.34, T.37, T.38, and the like) established by International Telecommunication Union Telecommunication (ITU-T) Standardization Sector have been known. Among the T series recommendations, the recommendation T.38 defines a communication procedure for real-time facsimile communication over IP network. Hereinafter, this communication procedure is referred to as a T38 communication procedure.

A general T38 communication procedure is performed after establishment of communication between a transmitter side (calling side) and a receiver side (called side).

UDP is used for transmission of packets performed between the transmitter side and the receiver side according to the T38 communication procedure. According to the UDP, delivery acknowledgement or the like is not performed. In addition, even if a packet is lost during the transmission, a process of restoring the lost packet is not performed. Therefore, the transmission rate by the UDP is higher than the transmission rate by Transmission Control Protocol (TCP) that belongs to the same transport layer as the UDP. Accordingly, the UDP is suitable for communication in which transmission objects are transmitted in real time, such as facsimile communication.

By the way, during transmission of packets according to the T38 communication procedure based on the UDP, some packets might be lost. In this case, the same packets as the lost packets need to be reliably transmitted to the destination. For this purpose, there has been known a technique in which a primary part and a secondary part are defined in a packet to be transmitted, and a packet to be originally transmitted (hereinafter referred to as “original packet”) is assigned to the primary part while a packet most-recently transmitted (hereinafter referred to as “redundant packet”) is assigned to the secondary part, followed by transmission of the packet to the destination.

However, when a plurality of packets are continuously transmitted to the receiver side in accordance with the above-mentioned T38 communication procedure, there may be a situation in which, even though all the packets have been transmitted, a response signal to the transmission is not returned from the receiver side due to loss of packets during the transmission. If no response signal is returned from the receiver side, the transmitter side retransmits the plurality of packets in the same manner as above after timeout has been determined on the transmitter side. In this case, in the secondary part of each packet retransmitted, a packet transmitted immediately before the determination of timeout is added as a redundant packet. For example, a case is considered in which three packets (first packet, second packet, and third packet) are continuously transmitted to the receiver side, and two packets more-recently transmitted are added as redundant packets to a secondary part of each packet. In this case, no response signal is returned from the receiver side, and timeout occurs, and then the three packets are retransmitted from the transmitter side. In the secondary part of the first packet retransmitted first, the third packet transmitted immediately before the timeout and the second packet transmitted immediately before the third packet are added as redundant packets. Therefore, upon receiving the retransmitted first packet, the receiver side obtains, in addition to the original first packet, the second packet and the third packet as the redundant packets, before the second packet and the third packets as the original packets are actually retransmitted. At this time point, if the receiver side transmits, to the transmitter side, a response signal indicating that all the packets (the first packet, the second packet, and the third packet) have been received, an undesirable situation occurs in which the receiver side performs the process of transmitting the response signal while the transmitter side continues to perform the process of retransmitting the second packet and the third packet as the original packets. Thus, both the transmitter side and the receiver side performing the transmission processes makes communication unstable, and in some cases, communication bug might occur between the transmitter side and the receiver side.

Such packet loss during transmission occurs when the communication state between the transmitter side and the receiver side is not good. Therefore, conventionally, when packets are retransmitted after timeout, in order to reliably retransmit the packets, the packets are retransmitted with the transmission rate being reset to be lower than the originally set transmission rate. For example, if timeout occurs after a DCS signal for notifying a transmission function used in a terminal on the transmitter side has been transmitted, the DCS signal is retransmitted with the transmission rate being reduced. In this case, the DCS signal to be retransmitted indicates the transmission rate lower than the transmission rate defined in the previously transmitted DCS signal in order to avoid loss of image information to be transmitted later. That is, the content of the DCS signal to be retransmitted is different from that of the previously transmitted DCS signal. In this case, the DCS signal before the change of the transmission rate, which has been transmitted before the timeout, might be added as a redundant packet to the packet received by the receiver side before the DCS signal to be retransmitted. At this time point, the receiver side obtains the DCS signal. However, even though the transmission rate has been changed, if the transmission rate on the receiver side is set based on the DCS signal before the change of the transmission rate, communication between the transmitter side and the receiver side becomes unstable because of the difference in the transmission rate between the transmitter side and the receiver side, which might cause loss of other packets to be transmitted later.

### SUMMARY

A network communication apparatus according to one aspect of the present disclosure receives packet data transmitted over an IP network in accordance with a transmission control scheme based on UDP. The network communication apparatus includes a last control signal determination portion, and a processing object exclusion portion. The last control signal determination portion determines whether a last control signal which is to be received in a last step in a continuous reception procedure of continuously receiving a plurality of the packet data, is included in one or a plurality of redundant packets added to the packet data received in the continuous reception procedure. The processing object exclusion portion, when the last control signal determination portion determines that the last control signal is included in the redundant packet, excludes the last control signal from processing objects to be processed in the network communication apparatus.

A facsimile apparatus according to another aspect of the present disclosure includes a network communication apparatus that receives packet data transmitted over an IP network in accordance with a transmission control scheme based on UDP. The facsimile apparatus receives image information transmitted in real time over the IP network. The facsimile apparatus includes a last control signal determination portion, and a processing object exclusion portion. The last control signal determination portion determines whether a last control signal which is to be received in a last step in a continuous reception procedure of continuously receiving a plurality of the packet data, is included in one or a plurality of redundant packets added to the packet data received in the continuous reception procedure. The processing object exclusion portion, when the last control signal determination portion determines that the last control signal is included in the redundant packet, excludes the last control signal from processing objects to be processed in the network communication apparatus.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing an outline of a structure of a multifunction peripheral according to an embodiment of the present disclosure.

FIG. 2 is a block diagram showing a structure of a control portion of the multifunction peripheral.

FIG. 3 is a sequence diagram showing a part of a T38 communication procedure performed between a multifunction peripheral and a facsimile apparatus.

FIG. 4 is a flowchart showing an example of a procedure of a communication interruption process executed by an IP gateway portion of the control portion.

FIG. 5 is a sequence diagram showing a T38 communication procedure performed between a transmitter side and a receiver side.

### DETAILED DESCRIPTION

Hereinafter, an embodiment of the present disclosure will be described with reference to the drawings. It is noted that the embodiment described below is merely an embodied example of the present disclosure, and can be modified as appropriate within a range not changing the gist of the present disclosure.

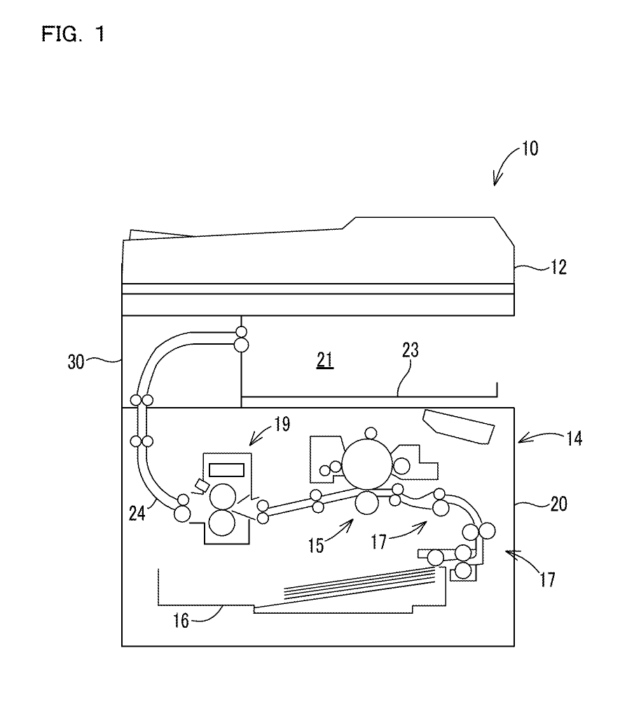

First, an outline of a structure of a multifunction peripheral 10 (an example of a facsimile apparatus) according to an example of the embodiment of the present disclosure will be described with reference to FIG. 1.

As shown in FIG. 1, the multifunction peripheral 10 is of so-called in-body sheet discharging type, and has various functions such as a facsimile function, a printing function, a copying function, and the like. The multifunction peripheral 10 includes: a scanner 12 that reads an image on a document sheet, which is an upper portion of the multifunction peripheral 10; and an image forming portion 14 of electrophotographic type, which is a lower portion of the multifunction peripheral 10. A sheet discharge portion 30 is provided as left-side portion of the multifunction peripheral 10 in FIG. 1. The sheet discharge portion 30 forms a sheet discharge space 21 between the image forming portion 14 and the scanner 12, and connects the image forming portion 14 with the scanner 12.

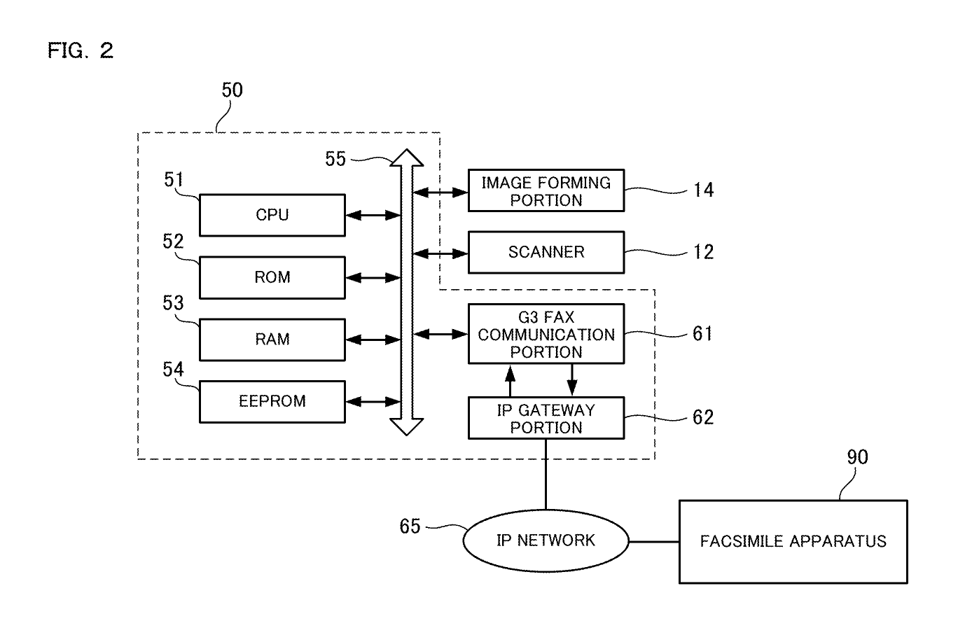

The image forming portion 14 forms a monochrome image on a print sheet, based on image data read by the scanner 12. The image forming portion 14 includes, as main components, a sheet feed tray 16, a plurality of conveying devices 17, a transfer device 15, a fixing device 19, and the like. When a print instruction is input, the image forming portion 14 performs monochrome printing or color printing of an input image on a print sheet by using a print material such as toner. The print sheet having the image formed thereon by the image forming portion 14 is conveyed through a conveying path 24 and discharged from the sheet discharge portion 30 to a sheet discharge tray 23 in the sheet discharge space 21. Since the image forming portion 14 of the above structure and the scanner 12 are known mechanisms, detailed descriptions thereof are omitted. The multifunction peripheral 10 is not limited to the above structure having the plurality of functions. The multifunction peripheral 10 may be structured as a facsimile apparatus that receives image data transmitted by facsimile communication from a communication network such as an IP network 65 (refer to FIG. 2) or a general telephone line and outputs the image data to a print sheet, and transmits image data on a document sheet read by the scanner 12 by facsimile communication via the above communication network.

As shown in FIG. 2, the multifunction peripheral 10 includes a control portion 50 that controls the operation of the multifunction peripheral 10 so as to realize the above-mentioned functions such as the facsimile function. The control portion 50 is configured as a microcomputer having, as main components, a CPU 51, a ROM 52, a RAM 53, and an EEPROM 54. The control portion 50 is connected, via a bus 55, to the scanner 12, the image forming portion 14, a G3 FAX communication portion 61, an IP gateway portion 62 (an example of a network communication apparatus), a non-illustrated motor driver, and the like.

In the ROM 52, programs for implementing the functions of the multifunction peripheral 10 and programs for controlling the operations of the components of the multifunction peripheral 10 are stored. The RAM 53 is used as a storage area in which various data to be used when the CPU 51 executes a program are temporarily stored or an area in which data or a program is loaded to be executed. In the EEPROM 54, image data transmitted/received by facsimile communication and various data used for processing according to the above program are stored.

CPU 51 is a calculation processing device that comprehensively controls: the control devices such as the G3 FAX communication portion 61 and the IP gateway portion 62 constituting the control portion 50; the scanner 12 and the image forming portion 14 connected to the bus 55; driving equipment such as a motor; and the like. The CPU 51 reads a program stored in the ROM 52 and data stored in the RAM 53 or the EEPROM 54, and performs processing according to the program.

The G3 FAX communication portion 61 is a communication modem for analog line that performs facsimile communication according to so-called G3 facsimile transmission procedure (G3 facsimile transmission protocol) defined in the recommendation T.30. The G3 FAX communication portion 61 is equipped with a communication control board including operation elements, memories and the like for controlling the facsimile communication. When performing facsimile communication via telephone line (general switched telephone network), the G3 FAX communication portion 61 performs facsimile communication with another facsimile apparatus via a non-illustrated Network Control Unit (NCU) which is a network control portion. On the other hand, when performing facsimile communication via the IP network 65, since protocol conversion is needed, the G3 FAX communication portion 61 performs facsimile communication with another facsimile apparatus 90 on the IP network 65 via the IP gateway portion 62 described later. The IP network 65 is interconnected computer networks utilizing IP technology, such as the Internet.

The IP gateway portion 62 is a communication control portion that performs protocol conversion between a protocol of the G3 facsimile transmission procedure and a protocol of the facsimile communication procedure in the IP network 65. The IP gateway portion 62 enables real-time facsimile communication via the IP network 65 between the G3 FAX communication portion 61 of the multifunction peripheral 10 and the other facsimile apparatus 90 (hereinafter referred to as “IP facsimile communication”). The IP gateway portion 62 performs IP facsimile communication with the other facsimile apparatus 90 connected to the IP network 65, in accordance with the communication procedure (T38 communication procedure) defined in the ITU-T recommendation T.38. The IP gateway portion 62 is equipped with a communication control board including operation elements, memories, and the like for controlling the IP facsimile communication. Specifically, the IP gateway portion 62 converts a facsimile signal or image information outputted from the G3 FAX communication portion 61 into an Internet Facsimile Protocol (IFP) packet (an example of packet data) that complies with the recommendation T.38, and outputs the packet to the IP network 65.

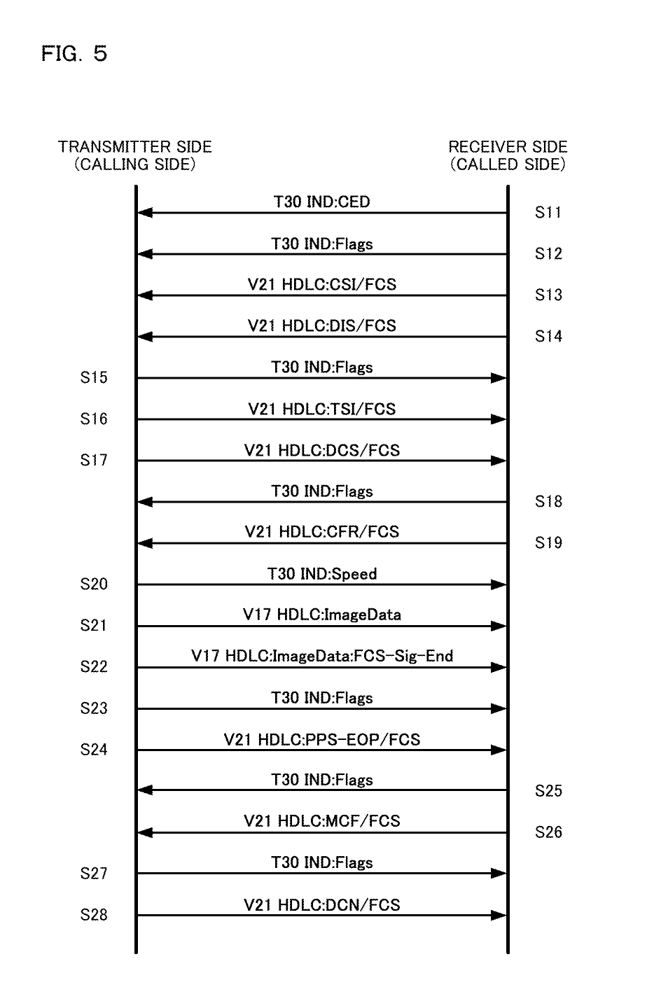

FIG. 5 shows a sequence of an example of a general T38 communication procedure. FIG. 5 shows a T38 communication procedure performed after communication has been established between a transmitter side (calling side) and a receiver side (called side). Hereinafter, the outline of the general T38 communication procedure will be described with reference to FIG. 5. In FIG. 5, S11, S12, . . . represent process procedure (step) numbers.

When communication has been established between the transmitter side and the receiver side, first, the receiver side transmits, to the transmitter side, a packet (T30 IND:CED) corresponding to a CED signal (called equipment identification signal) that is a response signal (tone signal) to a CNG signal from the transmitter side, in accordance with a procedure (a document facsimile transmission procedure in the general switched telephone network) defined in the ITU-T recommendation T.30 (S11). Thereafter, the receiver side transmits a packet (T30 IND:Flag) corresponding to a flag signal to the transmitter side (S12), and subsequently transmits a packet (V21 HDLC:CSI/FCS) corresponding to a CSI signal for notifying identification information of its terminal and a packet (V21 HDLC:DIS/FCS) corresponding to a DIS signal for notifying a standard transmission function of its terminal, successively to the transmitter side (S13, S14). The flag signal is a sync signal that is transmitted before transmission of a CSI signal or the like to enable a receiver side of the flag signal to receive the CSI signal or the like. In addition, in steps S13 and S14, an Frame Check Sequence (FCS) signal that enables a receiver side of this signal to check errors during transmission is also transmitted.

The CNG signal, the CED signal, the flag signal, the CSI signal, and the DIS signal which are described above, and a TSI signal, a DCS signal, a CFR signal, a training signal, an EOP signal, an MCF signal, and a DCN signal which are described later are signals (facsimile control signals) used in a group 3 facsimile (G3 facsimile) transmission procedure defined in the recommendation T.30. These signals are transmitted/received after being converted into packets corresponding to the T38 communication procedure by a gateway device provided in each of the transmitter side and the receiver side. For example, the above-mentioned “T30 IND:CED” indicates a packet into which the CED signal is converted. Other signals are represented in a similar manner in the following description.

When the above-mentioned four packets transmitted from the receiver side are received by the transmitter side, the transmitter side recognizes the identification information and the transmission function of the receiver side, and sets a transmission function and a modem speed or the like to be used by its terminal at that time, based on the transmission functions of the receiver side. Next, the transmitter side transmits a packet (T30 IND:Flags) corresponding to a flag signal to the receiver side (S15), and subsequently transmits, to the receiver side, a packet (V21 HDLC:TSI/FCS) corresponding to a TSI signal for notifying identification information (e.g., FAX number, IP address, or the like) of its terminal, and a packet (V21 HDLC:DCS/FCS) corresponding to a DCS signal for notifying the transmission function to be used by its terminal (S16, S17). Thereby, the receiver side recognizes the identification information of the transmitter side as the destination terminal, and the transmission function used by the transmitter side.

Thereafter, the receiver side transmits, to the transmitter side, a packet (T30 IND:Flags) corresponding to a flag signal, and subsequently, a packet (V21 HDLC:CFR/FCS) corresponding to a CFR signal for notifying that reception preparation is completed (S18, S19).

Upon the completion of preparation for transmission/reception of image information, the transmitter side transmits, to the receiver side, a packet (T30 IND:Speed) corresponding to a training signal for retraining of the modem (S20). Subsequently, the transmitter side divides image information (image data) to be transmitted into a plurality of pieces of information, and converts each piece of image information (hereinafter referred to as “division image information”) into a packet (represented as “V17 HDLC:ImageData” in FIG. 5), and transmits the packets to the receiver side in accordance with the transmission procedure based on the UDP (S21).

After a packet (represented as “V17 HDLC:ImageData:FCS-Sig-End” in FIG. 5) corresponding to the last division image information among the plurality of pieces of division image information has been transmitted to the receiver side (S22), the transmitter side transmits, to the receiver side, a packet (T30 IND:Flags) corresponding to a flag signal (S23), and subsequently transmits, to the receiver side, a packet (V21 HDLC:PPS-EOP/FCS) corresponding to an EOP signal indicating completion of transmission of image information (S24).

On the other hand, upon receiving the packet (T30 IND:Speed), the receiver side proceeds to preparation for reception of image information. After receiving all the plurality of packets including the division image information, the receiver side successively extracts the pieces of division image information included in the respective packets and restores them into the original image information, and thereafter, stores the image information in a storage medium such as a memory or a hard disk. Further, since the receiver side receives, after reception of the image information, the packet (V21 HDLC:PPS-EOP/FCS) indicating transmission completion, the receiver side can recognize that no image information will be transmitted after reception of this packet.

When the result of the reception of the image information is satisfactory, the receiver side transmits, to the transmitter side, a packet (T30 IND:Flags) corresponding to a flag signal, and subsequently, a packet (V21 HDLC:MCF/FCS) corresponding to an MCF signal indicating that the reception of the image information has been normally completed (S25, S26). Thereby, the transmitter side recognizes that the image information has been normally received by the receiver side. Thereafter, the transmitter side transmits, to the receiver side, a packet (T30 IND:Flags) corresponding to a flag signal, and subsequently, a packet (V21 HDLC:DCN/FCS) corresponding to a DCN signal for instructing restoration of the communication line between the transmitter side and the receiver side (S27, S28).

In the present embodiment, the transmission of the IFP packets according to the T38 communication procedure is performed by using the UDP. Generally, in a case where IFP packets are transmitted by using the UDP, in order to compensate loss of IFP packets during the transmission, a primary part and a secondary part are defined in each IFP packet to be transmitted, and an original packet to be originally transmitted is assigned to the primary part while one or a plurality of IFP packets (hereinafter referred to as “redundant packets”) that have previously been subjected to the transmission process are assigned to the secondary part, and thereafter, the IFP packet is transmitted to the destination. In this case, however, when the IFP packet to which the redundant packets are added is transmitted from the other facsimile apparatus 90 to the multifunction peripheral 10 via the IP network 65, the added redundant packets might make the communication state between the multifunction peripheral 10 and the facsimile apparatus 90 unstable.

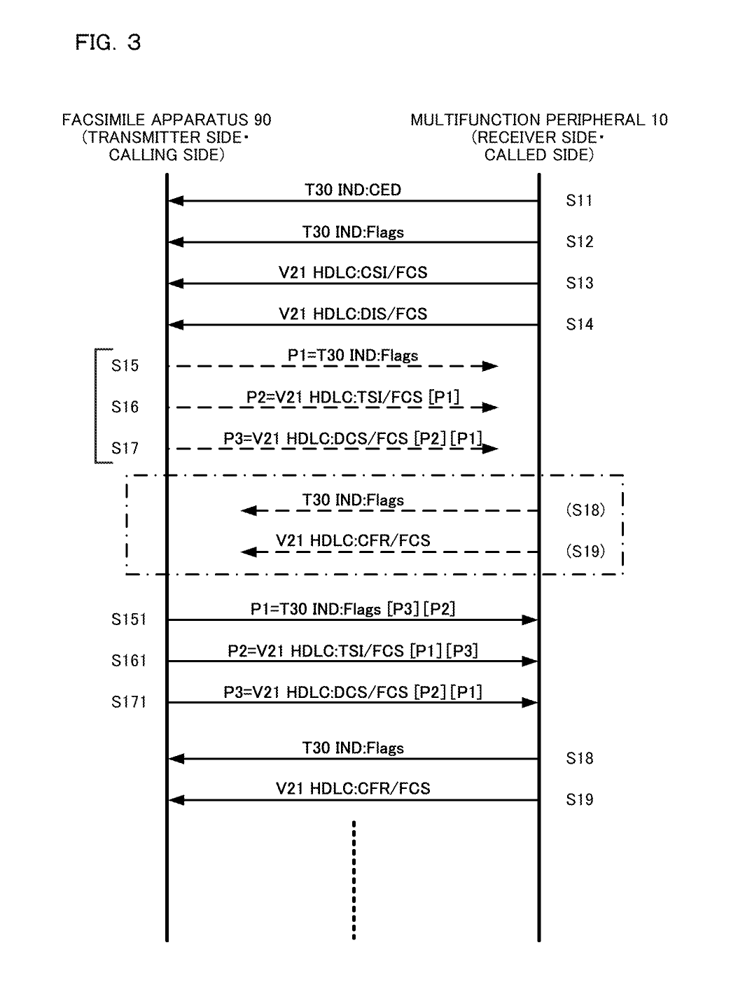

Now, a case is assumed where the transmitter side is the facsimile apparatus 90 and the receiver side is the multifunction peripheral 10, and IP facsimile communication is performed from the facsimile apparatus 90 to the multifunction peripheral 10, as shown in FIG. 3. In the following description, it is assumed that an IFP packet, to which two IFP packets having previously been transmitted are added as redundant packets, is transmitted. For example, as shown in steps S15 to S17 in FIG. 3, in a procedure of continuously transmitting three IFP packets to the multifunction peripheral 10, no redundant packet is added to a first packet P1 (T30 IND:Flags) firstly transmitted in step S15 because there is no IFP packet transmitted immediately before the first packet P1. Since the first packet P1 has been transmitted immediately before a second packet P2 (V21 HDLC:TSI/FCS[P1]) secondary transmitted in next step S16, the first packet is added to the second packet P2 as a redundant packet [P1]. As for a third packet P3 (V21 HDLC:DCS/FCS[P2][P1]) thirdly transmitted in next step S17, since the second packet P2 has been transmitted immediately before the third packet P3 and the first packet P1 has been transmitted before the second packet P2, the second packet P2 as a redundant packet [P2] and subsequently the first packet P1 as a redundant packet [P1] are added to the third packet P3.

As described above, even when the three IFP packets (the first packet P1, the second packet P2, and the third packet P3) are continuously transmitted from the facsimile apparatus 90 to the multifunction peripheral 10 by the IP facsimile communication, the three IFP packets might be lost for some reason before arriving at the IP gateway portion 62 of the multifunction peripheral 10. That is, the multifunction peripheral 10 might not be able to continuously receive the three IFP packets continuously transmitted. In this case, a CFR signal (V21 HDLC:CFR/FCS) indicating completion of reception preparation is not transmitted from the multifunction peripheral 10 to the facsimile apparatus 90, the facsimile apparatus 90 cannot receive the CFR signal (V21 HDLC:CFR/FCS) indicating completion of reception preparation from the multifunction peripheral 10. Therefore, the facsimile apparatus 90 retransmits the three IFP packets continuously after determination of timeout (S151, S161, S171). The facsimile apparatus 90 retransmits the IFP packets with the transmission rate being reset to be lower than the originally set transmission rate.

In this case, the third packet P3 and the second packet P2 that have previously been subjected to the transmission process are added as the redundant packets [P3] and [P2] to the first packet P1 transmitted in step S151. The first packet P1 and the third packet P3 that have previously been subjected to the transmission process are added as the redundant packets [P1] and [P3] to the second packet P2 transmitted in step S161. The second packet P2 and the first packet P1 that have previously been subjected to the transmission process are added as the redundant packets [P2] and [P1] to the third packet P3 transmitted in step S171. When the three IFP packets are retransmitted as described above, the IP gateway portion 62 of the multifunction peripheral 10 receives, in step S151, all the IFP packets that should be received. Therefore, the IP gateway portion 62 transmits, to the facsimile apparatus 90, a packet (V21 HDLC:CFR/FCS) of a CFR signal indicating completion of reception preparation at the timing of step S151, which might cause a difference in recognition between the transmitter side and the receiver side, resulting in a risk of unstable communication.

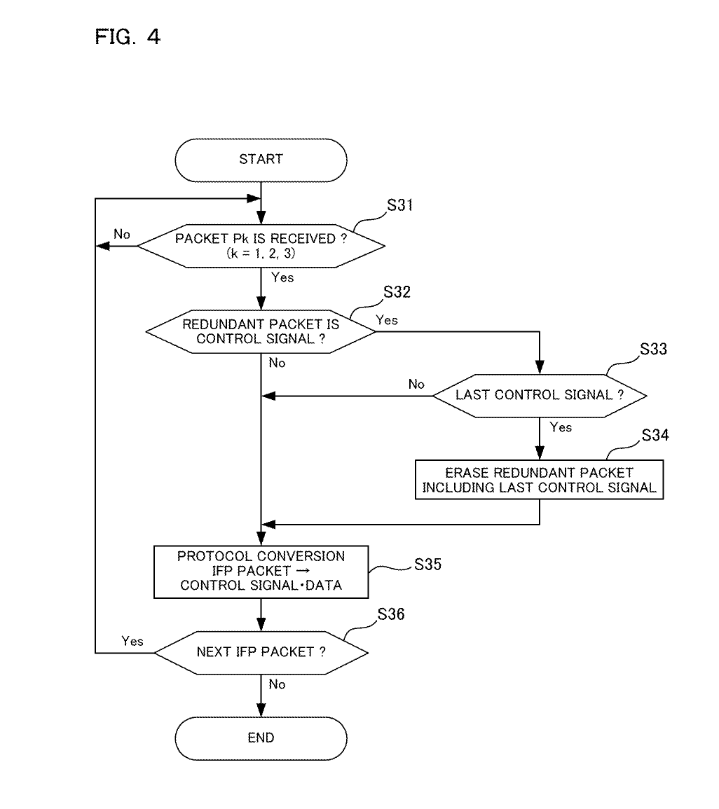

In the multifunction peripheral 10 of the present embodiment, in order to avoid such unstable communication caused by a difference in recognition, the IP gateway portion 62 executes a communication interruption process according to a procedure shown in FIG. 4. Hereinafter, the communication interruption process executed by the IP gateway portion 62 will be described with reference to the sequence shown in FIG. 3 and the flowchart shown in FIG. 4. In FIGS. 3 and 4, S31, S32, . . . represent process procedure (step) numbers. The following description will be given of a communication interruption process executed in continuous reception steps in which three IFP packets (a first packet P1, a second packet P2, and a third packet P3) continuously transmitted in steps S15 to S17 or steps S151 to S171 in FIG. 3 are continuously received on the multifunction peripheral 10 side.

Upon receiving the first packet P1 (T30 IND:Flags) from the facsimile apparatus 90 (Yes in S31), the IP gateway portion 62 checks whether a redundant packet is added to the first packet P1. When a redundant packet is added, the IP gateway portion 62 determines whether the redundant packet is a control signal (S32). The control signal is a facsimile control signal for the G3 FAX communication portion 61 of the multifunction peripheral 10. Specifically, the control signal is a facsimile control signal used in the group 3 facsimile (G3 facsimile) transmission procedure defined in the recommendation T.30. Examples of the control signal include a CNG signal, a CED signal, a flag signal, a CSI signal, a DIS signal, a TSI signal, a DCS signal, a CFR signal, a training signal, an EOP signal, an MCF signal, a DCN signal, and the like.

When it is determined that the redundant packet added to the first packet P1 is not the above-mentioned control signal (No in S32), the received first packet P1 and a redundant packet (if added to the first packet P1) are subjected to protocol conversion by the IP gateway portion 62 to be converted into a facsimile control signal and data in formats used in the G3 facsimile transmission procedure. Thereafter, the facsimile control signal and the data are transferred to the G3 FAX communication portion 61 (S35). When the first packet P1 transmitted in step S15 is received, since no redundant packet is added to this first packet P1, the process goes to step S35 without the necessity of determination in step S32.

On the other hand, when it is determined that the redundant packet added to the first packet P1 is a control signal (Yes in S32), it is determined in next step S33 whether the redundant packet is a last control signal. The last control signal is a facsimile control signal transmitted as an IFP packet to be received in the final step of the above-mentioned continuous reception steps on the multifunction peripheral 10 side. Specifically, the last control signal is a DCS signal (an example of the last control signal) transmitted as the third packet P3 in the present embodiment. The DCS signal is a facsimile control signal for notifying a transmission function (transmission rate and the like) used by the facsimile apparatus 90 to the IP gateway portion 62 and the G3 FAX communication portion 61 of the multifunction peripheral 10. Determination as to whether the redundant packet is the last control signal can be made by determining whether identification information indicating that the redundant packet is the last control signal is included in the redundant packet. Specifically, a facsimile control signal such as a DCS signal has an area named a control field for storing bit information indicating the last packet, and the above determination is made based on the bit information stored in the control field. In the present embodiment, the control field is located at the third byte from the beginning of the facsimile control signal. When bit information indicating “03” is written, the redundant packet is determined not to be the last control signal. When bit information indicating “13” is written, the redundant packet is determined to be the last control signal. In the present embodiment, it is assumed that bit information indicating “13” is written in the control field of the redundant packet determined to be the DCS signal. A last control signal determination portion is realized by the IP gateway portion 62 performing the determination process in step S33.

When it is determined in step S33 that the redundant packet is the DCS signal as the last control signal (Yes in S33), a process of excluding the DCS signal from objects to be processed in the IP gateway portion 62 and the G3 FAX communication portion 61 is performed. Specifically, the redundant packet determined to be the DCS signal is erased from the first packet P1 (S34). After the erasing of the redundant packet in step S34, the process goes to step S35. A processing object exclusion portion is realized by the IP gateway portion 62 performing the erasing process in step S34.

On the other hand, when it is determined in step S33 that the redundant packet is not the last control signal (No in S33), the process goes to step S35 without erasing the redundant packet. If a plurality of redundant packets are added to the first packet P1 received on the multifunction peripheral 10 side, after the redundant packet is determined to be the last control signal in step S33, not only the redundant packet but also a redundant packet transmitted before the redundant packet are erased.

In step S36, it is determined whether a next IFP packet to be subjected to the communication interruption process is received. When it is determined that the next IFP packet (e.g., the second packet P2) is present, step S31 and subsequent steps are repeated. On the other hand, if the received three IFP packets have been subjected to the communication interruption process, the series of process steps is completed.

The redundant packet [P3] (DCS signal packet) is added to the first packet P1 only when the first packet P1 is retransmitted in step S151. In this case, not only the redundant packet [P3] but also the redundant packet [P2] transmitted before the redundant packet [P3] are added to the first packet P1. Accordingly, in step S34, not only the redundant packet [P3] but also the redundant packet [P2] are erased to exclude the redundant packet [P2] from the objects to be processed in the IP gateway portion 62 and the G3 FAX communication portion 61.

The redundant packet [P3] (DCS signal packet) is added to the second packet P2 only when the second packet P2 is retransmitted in step S161. In this case, only the redundant packet [P3] added to the second packet P2 is erased in step S34. The redundant packet [P1] is also added to the second packet P2. In the present embodiment, however, among the plurality of redundant packets added, the redundant packet [P3] corresponding to the DCS signal as the last control signal and the redundant packet higher in arrival order than the redundant packet [P3] are erased. The redundant packet higher in arrival order than the redundant packet [P3] means an IFP packet to be transmitted or received before the IFP packet P3. For example, an IFP packet may be given arrival order information indicating its arrival order at the multifunction peripheral 10 side, and whether the IFP packet is higher or not in arrival order may be determined, when it is received, based on the arrival order information.

Since the communication interruption process is performed as described above, the G3 FAX communication portion 61 does not transmit a CFR signal indicating completion of reception preparation to the IP gateway portion 62 until reception of all the IFP packets is completed. That is, a packet (V21 HDLC:CFR/FCS) corresponding to the CFR signal is not transmitted from the IP gateway portion 62 to the facsimile apparatus 90 before completion of reception of all the IFP packets. Thereby, in each of the facsimile apparatus 90 on the transmitter side and the multifunction peripheral 10 on the receiver side, a difference in recognition about transmission and reception of the facsimile control signal does not occur, whereby the communication state between the facsimile apparatus 90 and the multifunction peripheral 10 is stabilized. Thus, loss of transmission objects such as packets is reduced. In particular, when the last control signal is a DCS signal, the transmission rate defined in the retransmitted DCS signal is set to be lower than the transmission rate defined in the DCS signal transmitted before the retransmitted DCS signal. Therefore, if the DCS signal is received as a redundant packet in step S151, since the setting of the transmission rate is different between the facsimile apparatus 90 side and the multifunction peripheral 10 side, communication between them becomes unstable, which might cause loss of other IFP packets and image information transmitted later. In the present embodiment, however, the above-mentioned communication interruption process resolves the unstable communication, i.e., stabilizes the communication state, and further, prevents loss of packets.

In the above embodiment, as a process of excluding the redundant packet determined to be the last control signal from the objects to be processed in the IP gateway portion 62 and the G3 FAX communication portion 61, erasing of the redundant packet is described. However, instead of erasing the redundant packet, for example, a process of removing the redundant packet from the IFP packet or a process of adding, to the redundant packet, information indicating that the redundant packet is inhibited or invalid to be processed, may be performed.

Further, as for the determination process in step S33, besides the determination method based on the bit information of the control field, a determination method based on a result of comparison between the redundant packet as the determination target and the last control signal may be adopted. Alternatively, the determination may be made based on whether the redundant packet as the determination target includes “HDLC-FCS-OK-Sig-End” indicating the last control signal. The “HDLC-FCS-OK-Sig-End” signal indicates an end of HDLC data.

In the above embodiment, the exemplary case is described in which three IFP packets (the first packet P1, the second packet P2, and the third packet P3) continuously transmitted in steps S15 to S17 or steps S151 to S171 in FIG. 3 are continuously received on the multifunction peripheral 10 side. However, the communication interruption process of the present embodiment is also applicable to a case where five IFP packets transmitted in steps S20 to S24 in FIG. 5 are continuously received on the multifunction peripheral 10 side. In this case, an example of the last control signal is an EOP signal that is a G3 facsimile procedure signal and indicates completion of image transmission. The last control signal may be any of other facsimile control signals such as a DIS signal, a DTC signal, a CTC signal, a CFR signal, an FTT signal, a CTR signal, an EOM signal, an MPS signal, a PPR signal, an RNR signal, an RR signal, an RTP signal, an RTN signal, an ERR signal, a DCN signal, a PPS-EOM signal, a PPS-MPS signal, and a PPS-EOP signal.

Further, in the above embodiment, the exemplary case is described in which one facsimile control signal is converted into one packet. However, the communication interruption process of the present embodiment is also applicable to a case where one facsimile control signal is converted into a plurality of packets to be transmitted or received, for example. In this case, in a control field of a redundant packet added to a last packet corresponding to one facsimile control signal, “HDLC-FCS-OK-Sig-End” indicating a last control signal is included. Therefore, it is possible to determine whether the packet includes a last control signal by determining whether “HDLC-FCS-OK-Sig-End” is included in the packet.

The present disclosure can be implemented as the multifunction peripheral 10 described for the above embodiment, and can also be implemented as a network communication apparatus having the function of the IP gateway portion 62 that relays communication between facsimile apparatuses.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A network communication apparatus that receives packet data transmitted over an IP network in accordance with a transmission control scheme based on UDP, the network communication apparatus comprising:
a last control signal determination portion configured to determine whether a last control signal which is to be received in a last step in a continuous reception procedure of continuously receiving a plurality of the packet data, is included in one or a plurality of redundant packets added to the packet data received in the continuous reception procedure, and
a processing object exclusion portion configured to, when the last control signal determination portion determines that the last control signal is included in the redundant packet, exclude the last control signal from processing objects to be processed in the network communication apparatus.

2. The network communication apparatus according to claim 1, wherein
in a case where a plurality of redundant packets to which order information indicating arrival order thereof is added, are added to the packet data, the processing object exclusion portion excludes, from the processing objects to be processed in the network communication apparatus, the redundant packet determined by the last control signal determination portion to include the last control signal, and the redundant packet higher in arrival order than the redundant packet including the last control signal.

3. The network communication apparatus according to claim 1, wherein
the last control signal determination portion determines that the last control signal is included in the redundant packet, when identification information indicating the last control signal is included in the redundant packet.

4. The network communication apparatus according to claim 3, wherein
the identification information is bit information indicating the last control signal in a control field provided in the redundant packet.

5. The network communication apparatus according to claim 3, wherein
the identification information is HDLC-FCS-OK-Sig-End indicating the last control signal in a control field provided in the redundant packet.

6. A facsimile apparatus including a network communication apparatus that receives packet data transmitted over an IP network in accordance with a transmission control scheme based on UDP, the facsimile apparatus being configured to receive image information transmitted in real time over the IP network, the facsimile apparatus comprising:
a last control signal determination portion configured to determine whether a last control signal which is to be received in a last step in a continuous reception procedure of continuously receiving a plurality of the packet data, is included in one or a plurality of redundant packets added to the packet data received in the continuous reception procedure, and
a processing object exclusion portion configured to, when the last control signal determination portion determines that the last control signal is included in the redundant packet, exclude the last control signal from processing objects to be processed in the network communication apparatus.
